(19) United States
(12) Patent Application Publication
(10) Pub. No.: US 2006/0186241 A1
(43) Pub. Date: Aug. 24, 2006

(54) Paper products in roll form having printed elements thereon

(76) Inventor: Bradley A. Cole, Winter Springs, FL (US)

Correspondence Address: BEUSSE WOLTER SANKS MORA & MAIRE, P. A., 390 NORTH ORANGE AVENUE, SUITE 2500, ORLANDO, FL, 32801, US

(21) Appl. No.: 11/332,067

(22) Filed: Jan. 14, 2006

Related U.S. Application Data
(63) Continuation of application No. 10/445,371, filed on May 23, 2003, now abandoned.
(60) Provisional application No. 60/383,032, filed on May 24, 2002.

(51) Int. Cl. B65H 16/00; G09F 11/00

(52) U.S. Cl. 242/160.4; 40/514; 5/600

(57) ABSTRACT

A plurality of elements are disposed on a continuous sheet of coiled paper product. The elements are repeated with a repetition rate determined by the use for the paper product. In the application to an examining room table, the repetition rate is determined by the length of the table.

This application claims the benefit of the application filed on May 23, 2003, and assigned application Ser. No. 10/445,371, which claims the benefit of the provisional patent application Ser. No. 60/383,032 filed on May 24, 2002.

### BACKGROUND OF THE INVENTION

The typical physician's examining room includes an examining table on which the patient lies or sits during the medical examination. The examining table is constructed with a metal frame and a cushioned upper surface that can be adjusted to support the patient in various positions during the examination. For sanitary purposes, it is known to provide a paper cover for the cushioned surface, where the paper is replaced after each patient visit.

The paper is provided from a substantially cylindrical paper roll stored in a cradle at the head or foot end of the examining table. To replace the paper between patient visits, the nurse or attendant separates the soiled length of paper from the roll and replaces it with a new length of paper withdrawn from the roll and extended over the cushioned upper surface. The paper is dispensed by grasping the leading edge of the paper and withdrawing paper as the roll rotates within the cradle. In lieu of disposing the paper roll in a cradle, the roll is rotatably mounted on an axle that extends through the roll and is appropriately mounted below the table surface at either the head or foot end.

Similar paper covers are also employed with head message tables, baby scales and chiropractic tables. In each case, the paper provides a clean and sanitary surface for the next user.

### BRIEF SUMMARY OF THE INVENTION

A length of paper for extending over a horizontal surface comprises a substantially cylindrical roll. A length of paper stock is coiled about the roll and the paper stock comprises a plurality of elements appearing on the paper at a repetition rate determined by the length of the horizontal surface.

### BRIEF DESCRIPTION OF THE DRAWINGS

The foregoing and other features of the invention will be apparent from the following more particular description of the invention, as illustrated in the accompanying drawings, in which like reference characters refer to the same parts throughout the different figures. The drawings are not necessarily to scale, emphasis instead being placed upon illustrating the principles of the invention.

FIG. 1 illustrates a plurality of paper segments constructed according to the teachings of the present invention.

FIG. 2 illustrates a stack of interfolded paper products constructed according to the teachings of the present invention.

FIGS. 3-5 illustrate various embodiments of the present invention associated with paper products coiled about a roll or tube.

FIG. 6 illustrates an examining table to which the teachings of the present invention can be applied.

FIG. 7 illustrates a head massage table to which the teachings of the present invention can be applied.

FIG. 8 illustrates a chiropractic table to which the teachings of the present invention can be applied.

FIG. 9 illustrates a baby weighing table to which the teachings of the present invention can be applied.

### DETAILED DESCRIPTION OF THE INVENTION

Before describing in detail the particular paper product rolls in accordance with the present invention, it should be observed that the present invention resides primarily in a novel and non-obvious combination of elements. Accordingly, the elements have been represented by conventional elements in the drawings, showing only those specific details that are pertinent to the present invention, so as not to obscure the disclosure with structural details that will be readily apparent to those skilled in the art having the benefit of the description herein.

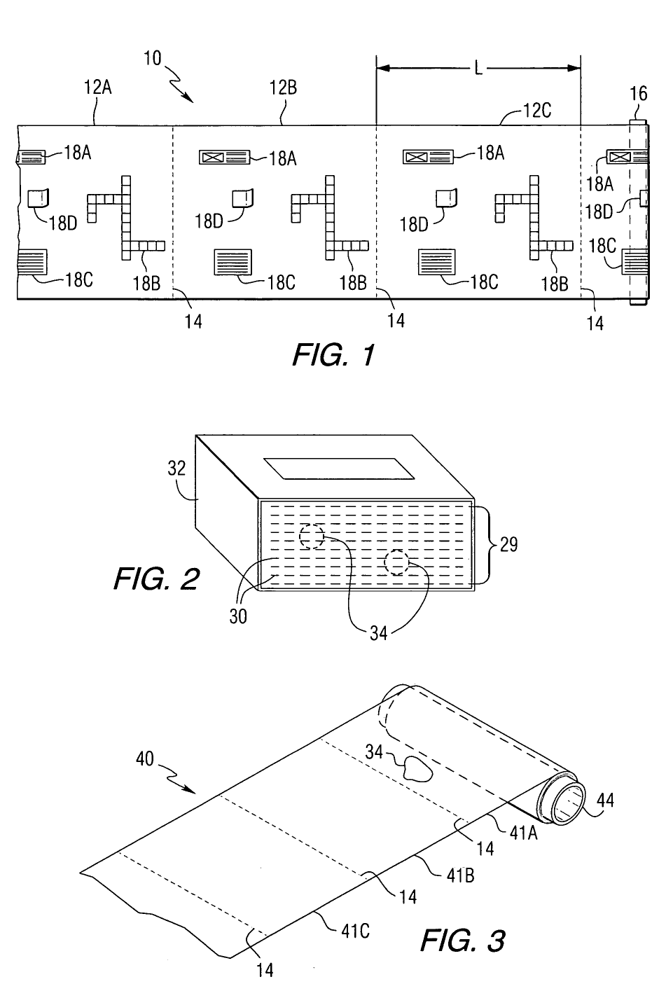

As illustrated in FIG. 1, according to one embodiment of the teachings of the present invention, the examining table paper 10 (also referred to as sanitary paper) is sectionalized into length regions 12A, 12B and 12C, each region having a length “L” approximately equivalent to the paper length required to cover an examining table. Section defining lines 14 represent perforations for ease in separating a soiled section of paper from a roll 16. In another embodiment the paper 10 is not perforated and thus the lines 14 represent imaginary lines of demarcation between regions 12A, 12B, 12C, etc. solely for the purpose of explaining the present invention.

In exemplary embodiments the length “L” is about three feet or about six feet, and the total paper length is about 225 feet. The paper width is dependent on the apparatus with which it is employed, including widths of 8 inches, 18 inches and 21 inches. Conventionally, as is known in the art, the examining table paper 10 comprises crepe machine grade paper.

Various items or elements (or groups of elements or items) are printed or embossed on or detachably or liftably mounted (using a liftable adhesive for easy removal) to the paper 10 with a repetition rate (or distance between items or elements) determined by the sectionalized length such that the items or elements (or groups of elements or items) appear in each region 12A, 12B and 12C. Thus one (or more) instance of each item or element (or groups of elements or items) is present in the paper length covering the examining room table. Each time a soiled section of the paper 10 is removed and replaced by a clean paper section the item or element appears in the clean paper section.

Those skilled in the art recognize that multiple embodiments of this concept are also implementable. For example, groups of items or elements are printed on or detachably mounted to the paper 10. Additionally, the repetition rate of the items or elements or groups thereof can be increased such that the items, elements, or groups thereof appear more than once in each region 12A, 12B and 12C. The repetition rate can also be decreased such that the items, elements, or groups thereof appear on some but not all of the paper sections 12A, 12B and 12C. Further, the repetition rate can be predetermined (e.g., every third or fifth section) or random. In yet another embodiment a first predetermined group of items or elements are alternated with a second group of items or elements.

FIG. 1 illustrates several different types of elements 18 that can be printed on or detachably mounted to the paper 10. Elements 18A are redeemable coupons for an over-the-counter or prescription medication commonly recommended by the physician. Elements 18B represent a game, such as a crossword puzzle. Elements 18C are detachable or perforated areas on which the physician makes notes for the patient for later review.

Generally, the elements 18 are intended to relate to the medical services provided, and further to enhance or add value to the patient's encounter with the physician. Exemplary element types include: inspirational, motivational, artistic, informative and educational. Inspirational elements include emotive artistic works with an inspirational message. Exemplary informative and educational elements, typically detachable or removable by the patient for review outside the physician's office, provide details of a medical condition or the medications available to treat a medical condition. The element 18 also includes a follow-up regimen for the patient to execute. A table in which the patient is to insert self-administered blood pressure measurements is one example of such a follow-up regimen. In yet another embodiment, the element 18 comprises a pharmaceutical questionnaire.

Games or other entertaining elements to occupy the patient's waiting time in the examining room can be printed on the paper 10. Game artwork thus appears in each section 12A, 12B and 12C. Exemplary word games include crossword puzzles, acrostics and anagrams. For a pediatrician's office one of the elements includes a child's tattoo that can be easily applied to and removed from the child's skin.

Value, reward, promotional or incentive elements include vendor discount or free-sample coupons or entries to contests sponsored by pharmaceutical companies or medical product vendors. Non-medical coupons can also be placed on the paper 10. The value elements, like all of the elements 18, in one embodiment are perforated for easy separation from the paper 10, or printed on a separate paper and attached to the paper with a liftable adhesive. Exemplary liftable elements are referred to by reference character 18D in FIG. 1.

In another embodiment, an element 18 comprises a game token for redemption if certain game conditions are satisfied. The redeeming party can be a supplier of medical products or the physician's office.

Elements 18C include a detachable physician's note area on which the physician makes notations for the patient to take from the examining room. For example, the patient may be instructed to perform certain daily exercises to alleviate an identified physical condition. Rather than expecting the patient to remember these instructions, the physician writes the instructions on the detachable area of the paper while explaining the instructions to the patient. In another embodiment the element 18C includes pre-printed material and blanks for the physician to insert the patient's name, date, condition, patient-specific instructions, etc.

The teachings of the present invention can also be applied to any paper or paper-like products or sheets that are serially dispensed from a container, housing or roll. For example, a stack 29 of interfolded products 30 (see FIG. 2) dispensed individually from a housing 32, include randomly placed game winning coupons, merchandise discount coupons or other element types 34 nested within the stack 29. When the user withdraws a product 30 from the housing, the element is also withdrawn.

According to another embodiment of the present invention, as illustrated in FIG. 3, a paper roll 40 (e.g., toilet tissue, gift wrap paper or paper towels) comprises sheets 41A, 41B and 41C coiled about a roll 44, and further including randomly spaced game elements 34 or merchandise coupons among the sheets 41. The sheets 41 are separated by sheet defining lines 14.

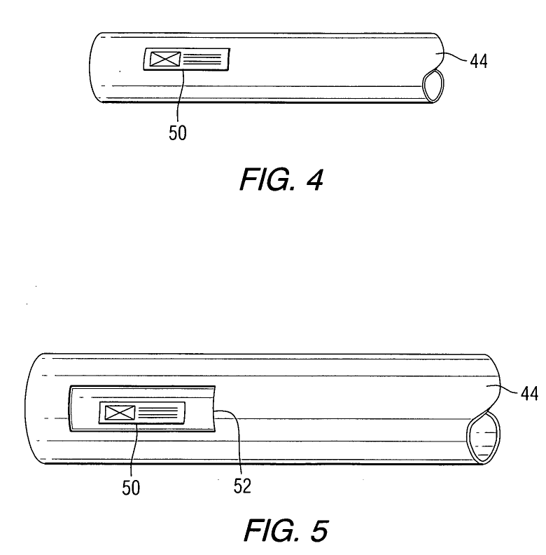

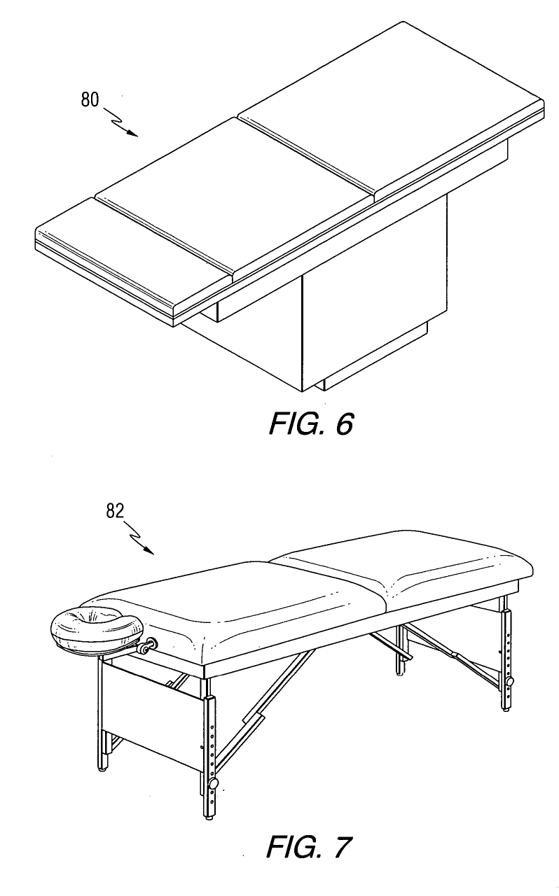

In another embodiment illustrated in FIG. 4, the roll 44 includes an element 50, for example, a game piece or merchandise discount coupon, that is not accessible until the entire product has been dispensed and the end of roll has been reached. Various prizes can be awarded by the product supplier, with valuable prizes awarded less frequently than less expensive prizes. In one embodiment the tube 44 represents a tube for coiling the examining table paper described above. The game piece or merchandise discount coupon is redeemed by a member of the physician's staff who is responsible for inserting a new paper roll into the dispensing mechanism of the examining table. Alternatively, all members of the staff can receive benefits from the coupon redemption.

In lieu of affixing the game piece or coupon 50 to the roll 44, an opening 52 is formed in the roll 44 and the element 50 is then visible or accessible through the opening 52. The element 50 is not exposed until after all the product has been dispensed from the roll 44.

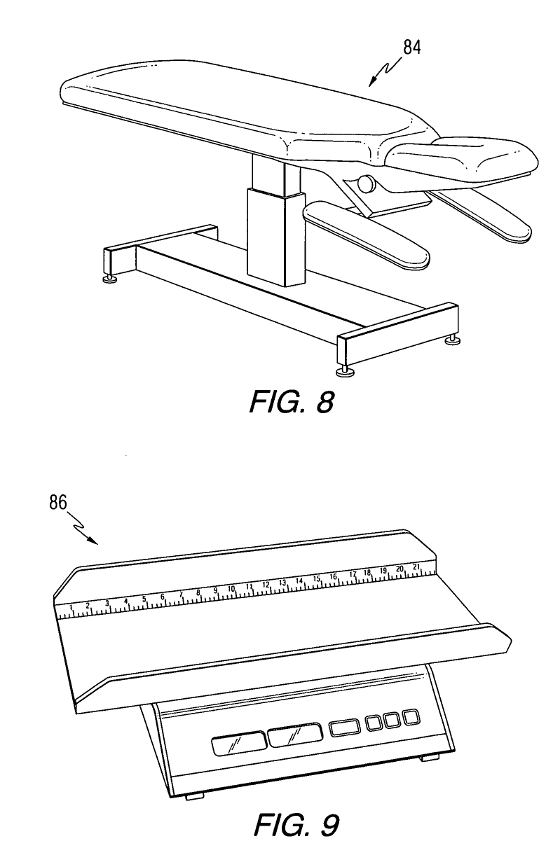

FIG. 6 illustrates an examining table 80 to which the teachings of the present invention can be applied. FIG. 7 illustrates a head massage table 82 to which the teachings of the present invention can be applied. FIG. 8 illustrates a chiropractic table 84 to which the teachings of the present invention can be applied. FIG. 9 illustrates a baby weighing table 86 to which the teachings of the present invention can be applied.

While specific applications and examples of the invention have been illustrated and discussed, the principals disclosed herein provide a basis for practicing the invention in a variety of ways and in a variety of applications. Numerous variations are possible within the scope of the invention. The invention is limited only by the claims that follow.

1.-8. (canceled)

9. An apparatus comprising:
a substantially cylindrical roll;
paper coiled about the roll, a portion of the paper for extending over a medical examining table; and
a group of medically related text items disposed on and spanning a distance on the paper, wherein the group is repeated to span substantially a length of the paper, wherein the distance is substantially equivalent to or less than an examining table length such that one group appears in the portion of the paper extended over the medical examining table and another group appears when a current portion is replaced by a subsequent portion dispensed from the roll.

10. The apparatus of claim 9 wherein the text items are printed on the paper.

11. The apparatus of claim 9 wherein the text items are detachably mounted to the paper.

12. The apparatus of claim 9 wherein the elements are liftably mounted to the paper.

13. The apparatus of claim 9 wherein the examining table comprises one of a head massage table, a chiropractic table and a baby weighing table.

14. The apparatus of claim 9 wherein the text items comprise at least one of informational elements or educational elements.

15. The apparatus of claim 9 wherein the text item comprise text items related to symptoms of a medical condition.

16. The apparatus of claim 9 wherein the text items comprise text items related to a treatment for a medical condition.

17. A plurality of interfolded paper sheets oriented in a vertical stack and enclosed within a housing, and a plurality of prize or informational elements dispersed randomly in the stack, such that when certain of the paper sheets are withdrawn from the housing, one of the prize or informational elements is withdrawn from the housing.

18. A substantially cylindrical roll for carrying a plurality of coiled serially connected sheets comprising one or more randomly spaced game elements or merchandise coupons embedded within the coil of sheets, wherein the one or more elements or coupons are not accessible until the roll is uncoiled to the location of the element or coupon.

19. A system comprising:
a table selected from the group consisting of an examining table for medical examination of a patient, a massage table, a infant scale and a chiropractic table, the table comprising a surface having a surface length defined by a distance between two spaced-apart edges;
a length of paper sectionalized into a plurality of regions, each region having a length approximately equivalent to the distance;
a group of medically related text items disposed on the length of paper and repeated within each one of the plurality of regions;
wherein one of the plurality of regions covers the surface to present an associated group of medically related text items to a patient to be treated; and
wherein removal of one of the plurality of regions from the surface and replacement thereof with a sequential one of the plurality of regions presents a sequential associated group of medically related text items to the patient.

20. A method of entertaining while instructing patients in an examination room having an examination table protected by a replaceable cover, the method comprising:
creating a plurality of artistic drawings and a plurality of messages concerning topics of interest to persons generally;
disposing the drawings and messages in predetermined patterns on an extended paper cover such that some of the drawings and messages are visible on the paper cover when the cover is placed on the examination table in view of a patient; and
changing the exposed portion of the cover after each patient to provide another set of drawings and messages for viewing by a subsequent patient.

21. The method of claim 20 wherein the messages are detachable or removable from the paper cover.

22. The method of claim 20 wherein the predetermined patterns are a function of a length of the examining table.

23. The method of claim 20 wherein a subsequent patient sees different drawings and messages from a previous patient.

24. The method of claim 20 wherein the plurality of messages comprise messages related to symptoms of a medical condition or to treatment of a medical condition.
